(19) United States
(12) Patent Application Publication
(10) Pub. No.: US 2016/0156653 A1
(43) Pub. Date: Jun. 2, 2016

(54) Method and Device for Identifying User Behavior

(71) Applicant: Xiaomi Inc., Beijing (CN)

(72) Inventors: Hua ZHANG, Beijing (CN); Yi Xia, Beijing (CN); Dingkun Hong, Beijing (CN); Haizhou Wang, Beijing (CN)

(73) Assignee: Xiaomi, Inc.

(21) Appl. No.: 14/933,197

(22) Filed: Nov. 5, 2015

Related U.S. Application Data
(63) Continuation of application No. PCT/CN2015/078019, filed on Apr. 30, 2015.

(30) Foreign Application Priority Data
Nov. 27, 2014 (CN) 201410708281.6

(51) Int. Cl. H04L 29/06; H04L 12/26

(52) U.S. Cl. CPC H04L 63/1425; H04L 43/10

(57) ABSTRACT

The present disclosure relates to a method and device for identifying user behavior, which identifies malicious behavior more effectively and accurately. The method includes: acquiring access behavior of a terminal within a sliding time window having a present period. The method evaluates an access pattern of the access behavior within the sliding time window, and determines whether the access behavior of the terminal is a malicious access based on the evaluated access pattern.

### CROSS-REFERENCE TO RELATED APPLICATIONS

This application is a Continuation Application of International Application PCT/CN2015/078019, with an international filing date of Apr. 30, 2015, which is based on and claims priority to Chinese Patent Application No. 201410708281.6, filed on Nov. 27, 2014, the entire contents of which are incorporated herein by reference.

### TECHNICAL FIELD

The present disclosure generally relates to the field of communications and computer processing, and more particularly, to a method and device for identifying user behavior.

### BACKGROUND

The statements in this section merely provide background information related to the present disclosure and may not constitute prior art.

With the development of the Internet, resource sharing may be realized through network. People may acquire more abundant information conveniently and quickly through the Internet. Many websites are confronted with various malicious attacks while people acquire information.

It is found that in related technologies a malicious attack frequently sends data packets to websites within a comparatively short time. Such events often occur in websites frequently visited within a short time in a rush to purchase commodities so as to rush to purchase cut-price commodities. Such a high-frequency access behavior generally is achieved by means of software to rush to purchase because such a high-frequency access behavior is unavailable by manual operation. In related technologies some measures may prevent such a malicious behavior but the effect is not desirable. Therefore, it is a problem to be solved urgently how to more efficiently identify a user's malicious behavior.

### SUMMARY

In order to overcome problems in related technologies, the present disclosure provides a method and device for identifying user behavior.

According to a first aspect of the embodiments of the present disclosure, a method for identifying user behavior is provided. The method includes acquiring access behavior of a terminal within a sliding time window having a preset period, evaluating an access pattern of the access behavior within the sliding time window, and determining whether the access behavior of the terminal is a malicious access based on the evaluated access pattern.

According to a second aspect of the embodiments of the present disclosure, a device for identifying user behavior is provided. The device includes an acquisition module configured to acquire an access behavior of a terminal within a sliding time window, an evaluation module configured to evaluate an access pattern of the access behavior within the sliding time window; and a determination module configured to determine whether the access behavior of the terminal is a malicious access based on the evaluated access pattern.

According to a third aspect of the embodiments of the present disclosure, a device for identifying user behavior is provided. The device includes a processor, and a memory configured to store instruction executable by the processor. The processor is configured to acquire access behavior of a terminal within a sliding time window having a preset period, evaluate an access pattern of the access behavior within the sliding time window, and determine whether the access behavior of the terminal is a malicious access based on the evaluated access pattern.

According to a fourth aspect of the embodiments of the present disclosure, it is provided a non-transitory computer-readable storage medium having stored therein instructions that, when executed by a processor of a server, causes the server to perform a method for identifying user behavior. The method comprises acquiring an access behavior of a terminal within a sliding time window having a preset period, evaluating an access pattern of the access behavior within the sliding time window, and determining whether the access behavior of the terminal is malicious based on the evaluated access pattern.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart showing a method for identifying user behavior according to an exemplary embodiment.

FIG. 2 is a flow chart showing a method for identifying user behavior according to an exemplary embodiment.

FIG. 3 is a flow chart showing a method for identifying user behavior according to an exemplary embodiment.

FIG. 4 is a block diagram showing a device for identifying user behavior according to an exemplary embodiment.

FIG. 5 is a block diagram showing an evaluation module according to an exemplary embodiment.

FIG. 6A is a block diagram showing an evaluation module according to an exemplary embodiment.

FIG. 6B is a block diagram showing an evaluation module according to an exemplary embodiment.

FIG. 7 is a block diagram showing an evaluation module according to an exemplary embodiment.

FIG. 8 is a block diagram showing a device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

In related art, network activities are increasingly frequent, and network merchants often launch promotions for seckilling (instant purchasing) commodities at a reduced price. For seckilling commodities at a low price, users may frequently visit websites of merchants during a short time. Some users may use software to rush to purchase. Software for rush to purchase may visit websites of merchants at a higher visit frequency than that of ordinary users. However, access behavior triggered by software for rush to purchase is malicious behavior, which may lead to breakdown of a website. One possible solution is as below: it is determined that whether the number of accesses within a preset time period is over a preset threshold value, and it is determined that a malicious access exists if the number of accesses within the preset time period is over the preset threshold value. However, this identification method is relatively simple, and unable to accurately identify whether the number of accesses results from user behavior or is triggered by the software for rush to purchase, and thus the identification results are not accurate enough.

In order to solve the problem, in the present embodiment, the access behavior of a terminal is monitored by means of a sliding time window, which may enable a relatively accurate identification on whether the access behavior of the terminal is malicious.

The sliding time window in the present embodiment is a dynamic time window, which has a fixed length such as 3,600 seconds. An end point of the sliding time window is always a current time point. Therefore the sliding time window moves as the time changes.

In related art, a solution for determining the number of accesses within a preset time period is as below: if the preset time period is 1,000 seconds, the number of accesses is determined once within 0˜1,000th second and determined once again within 1,001th˜2,000th second, and so on. However, it is unable to determine access behavior occurred within 500th˜1,500th second. In the present embodiment, a real-time detection is conducted as the sliding time window moves. For example, if the sliding time window has a length of 1,000 seconds, it is determined once within 0˜1,000th second, determined once again within 1st˜1,001th second, and determined once again within 2nd˜1,002th second, and so on. It is thus clear that compared with the technical solution of related art, the present disclosure may be more accurate in detection and identification of a malicious behavior.

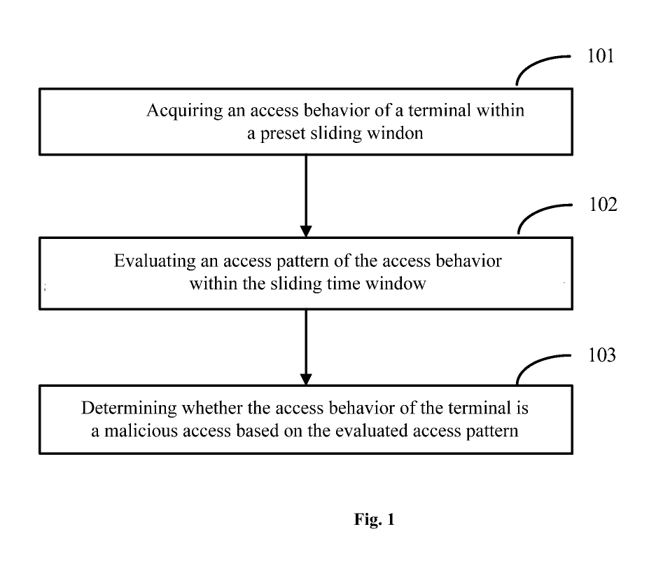

FIG. 1 is a flow chart showing a method for identifying user behavior according to an exemplary embodiment; as shown in FIG. 1, the method may be realized by a server, including following steps:

In Step 101, access behavior of a terminal within a preset sliding time window is acquired.

In Step 102, an access pattern of the access behavior within the sliding time window is evaluated.

In Step 103, it is determined whether the access behavior of the terminal is a malicious access based on the evaluated access pattern.

In the present embodiment, the access behavior of the terminal may be monitored in real time by means of the sliding time window, and it is possible to simultaneously monitor the access behavior within a period of time and evaluate whether the access behavior is malicious, with more accurate identification results. In the present embodiment, the behavior of a single terminal is monitored and evaluated, and the terminal may be determined by means of a user name, an IP (Internet Protocol) address, a MAC (Media Access Control) address or the like.

Various means may be adopted if it is identified that malicious access exists. For example, a terminal may be required to send a verification code to access a server, or the access of the user (or the terminal) may be provisionally blocked, or the user may be added into a blacklist so as to block the access of the user forever, or a warning message may be sent to the user, etc.

In an embodiment, Step 102 may be realized as Step A.

In Step A, an access pattern of the access behavior within the sliding time window is evaluated according to the access behavior in each time slice of the sliding time window.

In the present embodiment, the sliding time window may be further subdivided into a plurality of time slices, each of which has a same length (equational). For example, if a sliding time window including ten time slices has a length of 3,600 seconds, each time slice has a length of 360 seconds. In the present embodiment, user access behavior is monitored by taking the time slice as a unit, with a monitoring granularity being further reduced, which contributes to more accurately identifying malicious behavior. Furthermore, in the present embodiment, it is evaluated based on both the access behavior in each time slice and the whole access behavior within the sliding time window, with more accurate evaluation results.

In an embodiment, Step A may include Steps A1˜A2.

In Step A1, for each time slice, it is determined whether the number of accesses in the each time slice is over a preset threshold value of number of times for slicing, and acquired n time slices in which the number of accesses is over the preset threshold value of number of times for slicing. The sliding time window includes m time slices in total. In Step A2, it is determined whether a ratio of n to m is over a preset first ratio threshold value.

Step 103 may be realized as Step A3.

In Step A3, the access behavior of the terminal is determined as malicious access if the ratio of n to m is over the preset first ratio threshold value.

Namely, time slices are determined in which the number of accesses is beyond the preset threshold value of number of times for slicing. It is determined that whether the ratio of the number of time slices in which the number of access is over the threshold value of number of times for slicing to the total number of time slices is over the preset first ratio threshold value. Access behavior within the sliding time window is evaluated based on the determination result.

In the present embodiment, the number of accesses is determined as too high and malicious access exists if the ratio of the number of time slices in which the number of accesses is over the threshold value of number of times for slicing to the total number of time slices is over the preset first ratio threshold value, otherwise it is determined that no malicious access exists.

For example, if a sliding time window including ten time slices t1-t10 has a length of 3,600 seconds, each time slice has a length of 360 seconds. The numbers of accesses corresponding to ten time slices are respectively: t1=50, t2=60, t3=52, t4=55, t5=48, t6=56, t7=58, t8=54, t9=56 and t10=57. The threshold value of number of times for slicing is 50. Thus, except the time slice t5, the numbers of accesses corresponding to all other nine time slices are over the threshold value of number of times for slicing. The ratio of the number of time slices in which the number of accesses is over the threshold value of number of times for slicing to the total number of time slices is calculated as below: 9/10=90%. Supposing that the first ratio threshold value is 90%, it is determined that a malicious access exists in the sliding time window T by making a comparison between the ratio (90%) of the number of time slices in which the number of accesses is over the threshold value of number of times for slicing to the total number of time slices and the first ratio threshold value (90%) and by evaluating the access behavior.

In an embodiment, Step 102 may be realized as Solution B.

Solution B:

In Step B1, a time interval between two adjacent accesses is acquired for every two adjacent accesses within the sliding time window.

In Step B2, a time variance of accesses is calculated based on time intervals acquired.

In Step B3, the access behavior within the sliding time window is evaluated based on the time variance. It is determined whether the time variance is greater than a preset variance threshold value.

In Step 103, it is determined the access behavior of the terminal is malicious if the time variance is greater than the preset variance threshold value.

In the present embodiment, a comparison is made between the time variance and the preset variance threshold value. The variance is relatively large if it is greater than the preset variance threshold value, which means the fluctuation of the time interval of accesses is relatively large. In this case, it may be determined that the access behavior comes out from a user instead of software for rush to purchase, and further it may be determined that there is not malicious behavior. Otherwise, it may be determined that there is malicious behavior if the time variance is not greater than the preset variance threshold value.

For example, time intervals (x1, x2, x3, . . . , xn) between two adjacent accesses are acquired for every two adjacent accesses in the sliding time window, and x̅ is the average value of x1˜xn. The variance formula is as below:

$${s}^{2} = \frac{1}{n} [ {( x 1 - \overline{x} )}^{2} + {( x 2 - \overline{x} )}^{2} + … {( xn - \overline{x} )}^{2} ]$$

wherein s stands for the variance acquired from calculation.

In an embodiment, Solution B may be combined with Steps A1-A3. For example, a variance corresponding to each time slice is calculated so as to determine time slices in which the variance is greater than the variance threshold value and determine the ratio of the number of time slices in which the variance is greater than the variance threshold value to the total number of time slices, and the ratio is further compared with the first ratio threshold value to determine whether there is a malicious access.

In an embodiment, Solution B may be further modified. Step B3 may include Steps B31 and B32.

A time interval between two adjacent accesses is acquired for every two adjacent accesses within the sliding time window. And, a time variance of accesses is calculated based on time intervals acquired.

In Step B31, a ratio of the time variance to an average value of the time intervals is calculated.

In Step B32, it is determined whether the ratio is smaller than a preset second ratio threshold value. The access behavior within the sliding time window is evaluated based on the determination.

Step 103 may be realized as Step B33.

In Step B33, it is determined that the access behavior of the terminal is a malicious access if the ratio is smaller than the preset second ratio threshold value.

In the present embodiment, if the ratio of the time variance to the average value of the time intervals is smaller the preset second ratio threshold value, it means that the time variance is quite close to the average value of the time intervals. It may be determined that the access behavior is triggered and generated by software for rush to purchase and a malicious access exists. Otherwise, it is determined that the access behavior is triggered and generated by the user and no malicious access exists.

For example, the average value x is 1, and the time variance is 0.5. The ratio of the time variance to the average value is 50%, greater than the preset second ratio threshold value 10%. The variance (0.5) is relatively small, but is relatively large in deviation from the average value (1).

For another example, the average value x is 10, and the time variance is 0.5. The ratio of the time variance to the average value is 5%, smaller than the preset second ratio threshold value 10%. The time variance (0.5) is quite close to the average value as the average value (10) is relatively large.

In the present embodiment, access behavior may be more accurately evaluated by making a comparison of a degree of closeness between the variance and the average value (also referred to as a degree of deviation from another perspective).

In an embodiment, Step 102 may be realized as Solution C.

Solution C:

In Step C1, the total number of accesses within the sliding time window is acquired.

In Step C2, it is determined whether the total number is over a preset total number threshold value.

In Step C3, the access behavior within the sliding time window is evaluated according to a judgment result.

In the present embodiment, it may be determined that a PV (page view) is too high and a malicious access exists if the total number of accesses within the sliding time window is over the total number threshold value. Otherwise, it may be determined that no malicious access exists.

In an embodiment, Solution C may be combined with above Solutions. A determination based on Solution C is further executed on the basis of determination based on Step A and Solution B. A conclusion that a malicious access exists will not be made unless it is determined a malicious access exists according to all judgment results.

The implementation process for identifying user behavior will be introduced in detail by means of following several embodiments.

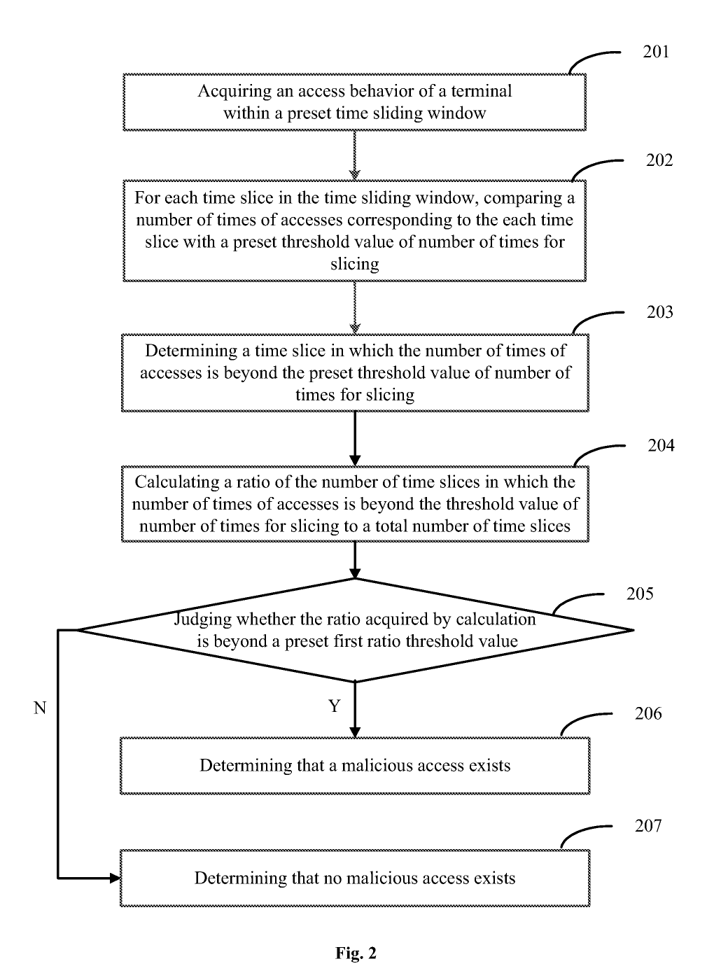

FIG. 2 is a flow chart showing a method for identifying user behavior according to an exemplary embodiment; as shown in FIG. 2, the method may be realized by a server, including following steps.

In Step 201, access behavior of a terminal within a preset sliding time window is acquired.

In Step 202, for each time slice in the sliding time window, a comparison is made between the number of accesses corresponding to the each time slice and a preset threshold value of number of times for slicing.

In Step 203, a time slice, in which the number of accesses is over the preset threshold value of number of times for slicing, is determined.

In Step 204, a ratio of the number of time slices in which the number of accesses is over the threshold value of number of times for slicing to the total number of time slices is calculated.

In Step 205, it is determined whether the ratio acquired by calculation is over a preset first ratio threshold value. Step 206 is executed if the ratio acquired by calculation is over the preset first ratio threshold value, otherwise Step 207 is executed.

In Step 206, it is determined that a malicious access exists.

In Step 207, it is determined that no malicious access exists.

In the present embodiment, the access behavior may be monitored more meticulously by means of time slices. It is possible to more accurately identify whether a malicious access exists by monitoring the number of times of access with a smaller granularity.

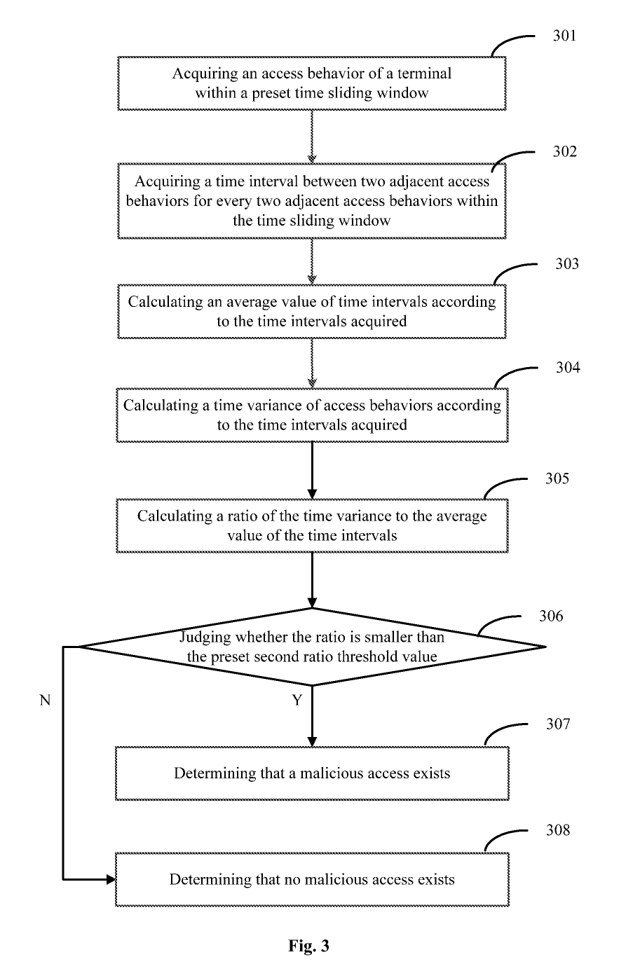

FIG. 3 is a flow chart showing a method for identifying user behavior according to an exemplary embodiment; as shown in FIG. 3, the method may be realized by a server, including following steps.

In Step 301, access behavior of a terminal within a preset sliding time window is acquired.

In Step 302, a time interval between two adjacent accesses is acquired for every two adjacent accesses within the sliding time window.

In Step 303, an average value of time intervals is calculated based on the time intervals acquired.

In Step 304, a time variance of accesses is calculated based on the time intervals acquired.

In Step 305, a ratio of the time variance to the average value of the time intervals is calculated.

In Step 306, it is determined whether the ratio is smaller than a preset second ratio threshold value. Step 307 is executed if the ratio is smaller than the preset second ratio threshold value, otherwise Step 308 is executed.

In Step 307, it is determined that a malicious access exists.

In Step 308, it is determined that no malicious access exists.

In the present embodiment, it is determined by means of variance that whether accesses are acquired evenly in time. It may be determined that the accesses are generated by software instead of a user if the accesses are acquired evenly in time. Otherwise, it may be determined that no malicious access exists. Hereby a malicious access may be identified more accurately.

The implementation for identification of user behavior is referred to hereinabove, and the implementation may be realized by a server; an internal structure and functions of a device are described hereinafter.

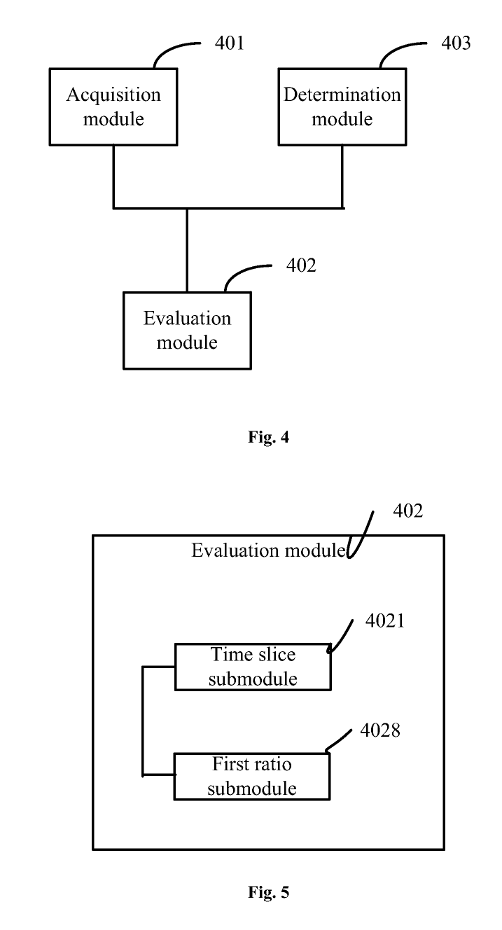

FIG. 4 is a block diagram showing a device for identifying user behavior according to an exemplary embodiment. Referring to FIG. 4, the device includes: an acquisition module 401, an evaluation module 402 and a determination module 403.

The acquisition module 401 is configured to acquire access behavior of a terminal within a preset sliding time window.

The evaluation module 402 is configured to evaluate an access pattern of the access behavior within the sliding time window.

The determination module 403 is configured to determine whether the access behavior of the terminal is a malicious access based on the evaluated access pattern.

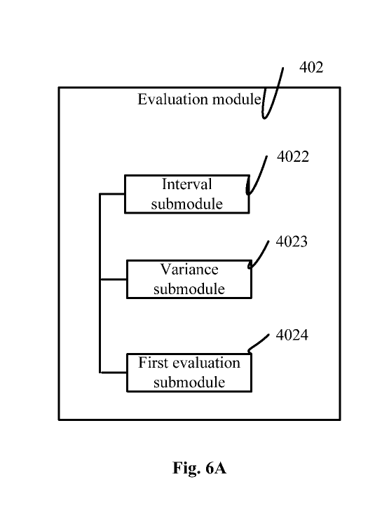

In an embodiment, the sliding time window includes m equational time slices; as shown in FIG. 5, the evaluation module 402 includes: a time slice submodule 4021 and a first ratio submodule 4028.

The time slice submodule 4021 is configured to determine whether the number of accesses for each time slice is over a preset threshold value of number of times for slicing, and acquire n time slices in which the number of accesses is over the preset threshold value of number of times for slicing.

The first ratio submodule 4028 is configured to determine whether the ratio of n to m is over a preset first ratio threshold value.

The determination module 403 determines the access behavior of the terminal as a malicious access if the ratio of n to m is over the preset first ratio threshold value.

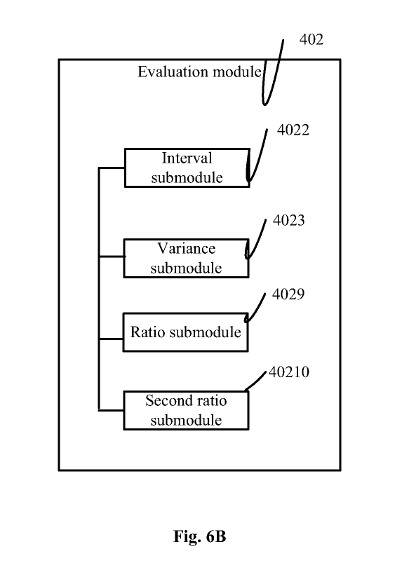

In an embodiment, as shown in FIG. 6A, the evaluation module 402 includes: an interval submodule 4022, a variance submodule 4023 and a first evaluation submodule 4024.

The interval submodule 4022 is configured to acquire a time interval between two adjacent accesses for every two adjacent accesses within the sliding time window.

The variance submodule 4023 is configured to calculate a time variance of accesses according to time intervals acquired.

The first evaluation submodule 4024 is configured to determine whether the time variance is greater than a preset variance threshold value.

The determination module 403 determines the access behavior of the terminal as a malicious access if the time variance is greater than a preset variance threshold value.

In an embodiment, the time slice submodule 4021 may also include: an interval submodule 4022, a variance submodule 4023 and a first evaluation submodule 4024.

In an embodiment, as shown in FIG. 6B, the evaluation module 402 includes: an interval submodule 4022, a variance submodule 4023, a ratio submodule 4029 and a second ratio submodule 40210.

The interval submodule 4022 is configured to acquire a time interval between two adjacent accesses for every two adjacent accesses within the sliding time window.

The variance submodule 4023 is configured to calculate a time variance of accesses according to time intervals acquired.

The ratio submodule 4029 is configured to calculate a ratio of the time variance to an average value of the time intervals.

The second ratio submodule 40210 is configured to determine whether the ratio is smaller than a preset second ratio threshold value.

The determination module 403 determines the access behavior of the terminal as a malicious access if the ratio is smaller than the preset second ratio threshold value.

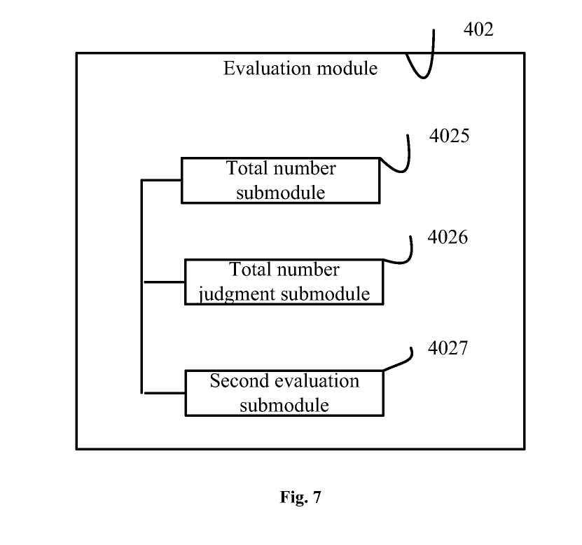

In an embodiment, as shown in FIG. 7, the evaluation module 402 includes: a total number submodule 4025, a total number judgment submodule 4026 and a second evaluation submodule 4027.

The total number submodule 4025 is configured to acquire a total number of accesses within the sliding time window.

The total number judgment submodule 4026 is configured to judge whether the total number is over a preset total number threshold value.

The second evaluation submodule 4027 is configured to evaluate the access behavior within the sliding time window based on a determination result.

With regard to the device in the above embodiment, detailed description of specific modes for performing operation of modules has been made in the embodiment related to the method, thus no detailed illustration will be made herein.

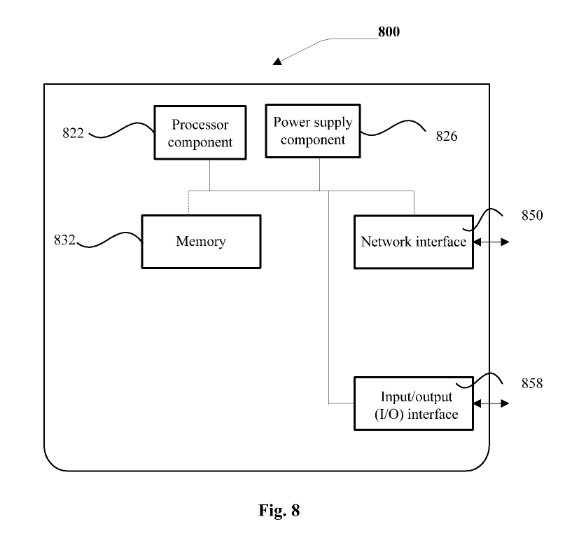

FIG. 8 is a block diagram of a device 800 for identifying user behavior according to an exemplary embodiment. For example, the device 800 can be provided as a computer. Referring to FIG. 8, the device 800 includes a processor component 822, and further includes one or more processors, and memory resource represented by the memory 832 configured to store instructions such as an application program executable by the processor component 822. The application program stored in the memory 832 may include one or more modules each of which is corresponding to a set of instructions. In addition, the processor component 822 is configured to execute instructions so as to execute the foregoing method for identifying user behavior.

The device 800 may also include a power supply component 826 configured to execute the power management of the device 800, a wired or wireless network interface 850 configured to connect the device 800 to the network, and an input/output (I/O) interface 858. The device 800 can operate an operating system based on and stored in the memory 832, for example, Windows Server™, Mac OS X™, Unix™, Linux™, FreeBSD™ or other similar operating systems.

A device for identifying user behavior includes a processor, and a memory configured to store instruction executable by the processor. The processor is configured to acquire an access behavior of a terminal within a sliding time window having a preset period, evaluate an access pattern of the access behavior within the sliding time window, and determine whether the access behavior of the terminal is a malicious access based on the evaluated access pattern.

The sliding time window includes m equational time slices. The processor also can be configured to determine whether the number of accesses for each time slice is over a preset threshold value of number of times for slicing, and acquires n time slices in which the number of accesses is over the preset threshold value of number of times for slicing, and determines whether a ratio of n to m is over a preset first ratio threshold value. The processor can be further configured to determine the access behavior of the terminal as a malicious access if the ratio of n to m is over the preset first ratio threshold value.

The processor also can be configured to acquire a time interval between two adjacent accesses for every two adjacent accesses within the sliding time window, calculate a time variance of accesses based on time intervals acquired, and determine whether the time variance is greater than a preset variance threshold value. The processor can be further configured to determine the access behavior of the terminal as a malicious access if the time variance is greater than the preset variance threshold value.

The processor also can be configured to acquire a time interval between two adjacent accesses for every two adjacent accesses within the sliding time window, calculate a time variance of accesses based on time intervals acquired, calculate a ratio of the time variance to an average value of the time intervals, and determine whether the ratio is smaller than a preset second ratio threshold value. The processor can be further configured to determine the access behavior of the terminal as a malicious access if the ratio is smaller than the preset second ratio threshold value.

The processor also can be configured to acquire the total number of accesses within the sliding time window, determine whether the total number is over a preset total number threshold value, and evaluates the access pattern of the access behavior within the sliding time window based on the determination.

A non-transitory computer-readable storage medium, wherein instructions in the storage medium are executed by a processor of a server so that the server may execute a method for identifying user behavior. The method includes acquiring an access behavior of a terminal within a sliding time window having a preset period, evaluating an access pattern of the access behavior within the sliding time window, and determining whether the access behavior of the terminal is a malicious access based on the evaluated access pattern.

The sliding time window includes m equational time slices. The step of evaluating an access pattern of the access behavior within the sliding time window include determining whether the number of accesses for each time slice is over a preset threshold value of number of times for slicing, and acquiring n time slices in which the number of accesses is over the preset threshold value of number of times for slicing, and determining whether a ratio of n to m is over a preset first ratio threshold value. The step of determining whether the access behavior of the terminal is a malicious access based on evaluated access pattern includes determining the access behavior of the terminal as a malicious access if the ratio of n to m is over the preset first ratio threshold value.

The step of evaluating an access pattern of the access behavior within the sliding time window includes acquiring a time interval between two adjacent accesses for every two adjacent accesses within the sliding time window, calculating a time variance of accesses based on time intervals acquired, and determining whether the time variance is greater than a preset variance threshold value. The step of determining whether the access behavior of the terminal is a malicious access based on the evaluated access pattern includes determining the access behavior of the terminal as a malicious access if the time variance is greater than the preset variance threshold value.

The step of evaluating an access pattern of the access behavior within the sliding time window includes acquiring a time interval between two adjacent accesses for every two adjacent accesses within the sliding time window, calculating a time variance of accesses based on time intervals acquired, calculating a ratio of the time variance to an average value of the time intervals, and determining whether the ratio is smaller than a preset second ratio threshold value. The step of determining whether the access behavior of the terminal is a malicious access based on the evaluated access pattern includes determining the access behavior of the terminal as a malicious access if the ratio is smaller than the preset second ratio threshold value.

The step of evaluating an access pattern of the access behavior within the sliding time window includes acquiring the total number of accesses within the sliding time window, determining whether the total number is over a preset total number threshold value, and evaluating the access behavior within the sliding time window based on the determination.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for identifying user behavior in a network comprising:
acquiring, at a server, access behavior of a terminal within a sliding time window having a preset period;
evaluating an access pattern of the access behavior within the sliding time window; and
determining whether the access behavior of the terminal is malicious based on the evaluated access pattern.

2. The method for identifying user behavior according to claim 1, wherein the sliding time window comprises m equational time slices, and evaluating an access pattern of the access behavior within the sliding time window comprises:
determining whether a number of accesses for each time slice is over a preset threshold value, and acquiring n time slices in which the number of accesses is over the preset threshold value, and
the determining whether the access behavior of the terminal is malicious based on the evaluated access pattern comprises:
determining that a ratio of n to m is over a preset first ratio threshold value.

3. The method for identifying user behavior according to claim 1, wherein the evaluating an access pattern of the access behavior within the sliding time window comprises:
acquiring a time interval between two adjacent accesses for every two adjacent accesses of the access behavior within the sliding time window; and
calculating a time variance of accesses based on time intervals acquired, and
the determining whether the access behavior of the terminal is malicious based on the evaluated access pattern comprises:
determining that the time variance is greater than a preset variance threshold value.

4. The method for identifying user behavior according to claim 1, wherein the evaluating an access pattern of the access behavior within the sliding time window comprises:
acquiring a time interval between two adjacent accesses for every two adjacent accesses within the sliding time window;
calculating a time variance of accesses based on time intervals acquired; and
calculating a ratio of the time variance to an average value of the time intervals, and
the determining whether the access behavior of the terminal is malicious based on the evaluated access pattern comprises:
determining that the ratio is smaller than a preset second ratio threshold value.

5. The method for identifying user behavior according to claim 1, wherein the evaluating an access pattern of the access behavior within the sliding time window comprises:
acquiring a total number of accesses within the sliding time window;
determining whether the total number is over a preset total number threshold value; and
evaluating the access pattern of the access behavior within the sliding time window based on the determination.

6. The method for identifying user behavior according to claim 1, further comprising:
identifying the terminal based on one of user name, internet protocol (IP) address, and a Media Access Control (MAC) address.

7. The method for identifying user behavior according to claim 1, wherein a starting point of the sliding time window changes in real time.

8. A device for identifying user behavior, comprising:
a processor; and
a memory configured to store instruction executable by the processor,
wherein, the processor is configured to:
acquire access behavior of a terminal within a sliding time window having a preset period;
evaluate an access pattern of the access behavior within the sliding time window; and
determine whether the access behavior of the terminal is malicious based on the evaluated access pattern.

9. The device for identifying user behavior according to claim 8, wherein the sliding time window includes m equational time slices, and
in evaluating the access pattern of the access behavior within the sliding time window, the processor is further configured to:
determine whether a number of accesses for each time slice is over a preset threshold value, and acquire n time slices in which the number of accesses is over the preset threshold value, and
in determining whether the access behavior of the terminal is malicious based on the evaluated access pattern, the processor is further configured to:
determine that a ratio of n to m is over a preset first ratio threshold value.

10. The device for identifying user behavior according to claim 8, wherein, in evaluating the access pattern of the access behavior within the sliding time window, the processor is further configured to:
acquire a time interval between two adjacent accesses for every two adjacent accesses of the access behavior within the sliding time window;
calculate a time variance of accesses based on time intervals acquired; and
in determining whether the access behavior of the terminal is malicious based on the evaluated access pattern, the processor is further configured to:
determine that the time variance is greater than a preset variance threshold value.

11. The device for identifying user behavior according to claim 8, wherein, in evaluating the access pattern of the access behavior within the sliding time window, the processor is further configured to:
acquire a time interval between two adjacent accesses for every two adjacent accesses of the access behavior within the sliding time window;
calculate a time variance of accesses based on time intervals acquired; and
calculate a ratio of the time variance to an average value of the time intervals, and
in determining whether the access behavior of the terminal is malicious based on the evaluated access pattern, the processor is further configured to:
determine that the ratio is smaller than a preset second ratio threshold value.

12. The device for identifying user behavior according to claim 8, wherein, in evaluating the access pattern of the access behavior within the sliding time window, the processor is further configured to:
acquire a total number of accesses of the access behavior within the sliding time window;
determine whether the total number is over a preset total number threshold value; and
evaluate the access pattern of the access behavior within the sliding time window based on the determination.

13. The device for identifying user behavior according to claim 8, wherein, in evaluating the access pattern of the access behavior within the sliding time window, the processor is further configured to:
identify the terminal based on one of user name, internet protocol (IP) address, and a Media Access Control (MAC) address.

14. The device for identifying user behavior according to claim 8, wherein a starting point of the sliding time window changes in real time.

15. A non-transitory computer-readable storage medium having stored therein instructions that, when executed by a processor of a server, causes the server to perform a method for identifying user behavior, the method comprising:
acquiring access behavior of a terminal within a sliding time window having a preset period;
evaluating an access pattern of the access behavior within the sliding time window; and
determining whether the access behavior of the terminal is malicious based on the evaluated access pattern.

16. The non-transitory computer-readable storage medium according to claim 15, wherein the sliding time window comprises m equational time slices;
the evaluating an access pattern of the access behavior within the sliding time window comprises:
determining whether a number of accesses for each time slice is over a preset threshold value, and acquiring n time slices in which the number of accesses is over the preset threshold value, and
the determining whether the access behavior of the terminal is malicious based on the evaluated access pattern comprises:
determining that a ratio of n to m is over a preset first ratio threshold value.

17. The non-transitory computer-readable storage medium according to claim 15, wherein the evaluating an access pattern of the access behavior within the sliding time window comprises:
acquiring a time interval between two adjacent accesses for every two adjacent accesses within the sliding time window; and
calculating a time variance of accesses based on time intervals acquired, and
the determining whether the access behavior of the terminal is malicious based on the evaluated access pattern comprises:
determining that the time variance is greater than a preset variance threshold value.

18. The non-transitory computer-readable storage medium according to claim 15, wherein the evaluating an access pattern of the access behavior within the sliding time window comprises:
acquiring a time interval between two adjacent accesses for every two adjacent accesses within the sliding time window;
calculating a time variance of accesses according to time intervals acquired; and
calculating a ratio of the time variance to an average value of the time intervals, and
the determining whether the access behavior of the terminal is malicious based on the evaluated access pattern comprises:
determining that the ratio is smaller than a preset second ratio threshold value.

19. The non-transitory computer-readable storage medium according to claim 15, wherein the evaluating an access pattern of the access behavior within the sliding time window comprises:
acquiring a total number of accesses within the sliding time window;
determining whether the total number is over a preset total number threshold value; and
evaluating the access pattern of the access behavior within the sliding time window based on the determination.

20. The non-transitory computer-readable storage medium according to claim 15, wherein the evaluating an access pattern of the access behavior within the sliding time window comprises:
identifying the terminal based on one of user name, internet protocol (IP) address, and a Media Access Control (MAC) address.
